(19) United States
(12) Patent Application Publication
(10) Pub. No.: US 2010/0309278 A1
(43) Pub. Date: Dec. 9, 2010

(54) OPTICAL SCANNING DEVICE, BEAM CURVATURE CORRECTION METHOD AND IMAGE FORMING APPARATUS

(75) Inventors: Masahiro KODO, Shizuoka (JP); Takeshi ENDO, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/790,576

(22) Filed: May 28, 2010

Related U.S. Application Data
(60) Provisional application No. 61/183,660, filed on Jun. 3, 2009.
(60) Provisional application No. 61/184,708, filed on Jun. 5, 2009.

(51) Int. Cl. B41J 2/435; G02B 26/08

(52) U.S. Cl. 347/224; 359/201.2

(57) ABSTRACT

An optical scanning device of an embodiment includes: a deflection unit which deflects a light beam emitted from a light source, in a main scanning direction; a reflection mirror which reflects the light beam from the deflection unit toward an image carrier; a supporting member which supports each of two ends of the reflection mirror; a plate situated on a back side that is opposite to an incident surface for the light beam, of the reflection mirror, along the axial line of the reflection mirror; a holding unit which holds an end of the incident surface with an end of the plate from the back side of the reflection mirror; and a pressing member which presses the back side of the reflection mirror in a curvature correcting direction against the plate.

### CROSS-REFERENCE TO RELATED APPLICATION

This application is based upon and claims the priority of U.S. Provisional Application No. 61/183,660, file on Jun. 3, 2009, and U.S. Provisional Application No. 61/184,708, filed on Jun. 5, 2009, the entire contents of which are incorporated herein by reference.

### FIELD

Embodiments described herein relates to an optical scanning device, a beam curvature correction method and an image forming apparatus that correct color deviation due to beam curvature at the time of forming a color image.

### BACKGROUND

An image forming apparatus such as an MFP (multi-function peripherals), color copier or printer has an optical scanning device. The optical scanning device includes a laser diode as a light source, a polygon mirror which deflects a laser beam in a main scanning direction, a deflection lens (fθ lens), a reflection mirror and the like. The optical scanning device may also be called laser scanning unit.

The optical scanning device has the light source, the polygon mirror, the deflection lens, the reflection mirror and the like housed within a casing. A laser beam that exits the light source is passed through the polygon mirror, then transmitted through the deflection lens and reflected by the reflection mirror and thus travels toward a photoconductive drum, thus performing scanning.

The reflection mirror has a reflection layer that is formed by evaporation of aluminum on a bar-like body with a quadrilateral cross section. The reflection mirror is supported by a supporting part provided in the casing. The optical scanning device has an adjustment mechanism which adjusts the angle of the mirror.

Meanwhile, since the reflection mirror may curve, if scanning with a laser beam is carried out using the reflection mirror, a difference in the quantity of curvature is generated between the edges and central part of the mirror even with a relatively small quantity of curvature. Therefore, in a resulting image, a line written by scanning once is curved and image quality is deteriorated. In a color copier, since plural mirrors are used to reflect a laser beam, a deviation between colors (color deviation) is generated.

In order to correct the curvature of the reflection mirror, there is an example in which a separate member is attached to a back side (non-reflecting surface) at the central part of the mirror and the back side of a reflecting surface of the mirror is pressurized. However, there is a problem that a space for attaching the separate member is required, causing complexity of the structure and increase in cost.

### DESCRIPTION OF THE DRAWINGS

FIG. 1 shows an overall configuration of an image forming apparatus according to an embodiment.

FIG. 2 shows the image forming apparatus including an optical scanning device according to the embodiment.

FIG. 3 is a perspective view showing the overall configuration of the optical scanning device.

FIG. 4 is a perspective view showing a mirror unit of the optical scanning device.

FIG. 5 is an explanatory view showing the relation between the curvature of mirrors and the curvature of laser beams.

FIG. 6A is a perspective view showing the configuration of a correction member which corrects the curvature of the mirror.

FIG. 6B is a perspective view showing the state where the correction member is attached to a mirror.

FIG. 6C is a sectional view taken along an axial line X shown in FIG. 6B.

FIG. 7 is an enlarged perspective view showing a distal end part of the mirror and a spring member shown in FIG. 6B.

FIG. 8 is an enlarged perspective view showing a central part of the mirror and a pressing member shown in FIG. 6B.

FIG. 9 is a perspective view showing a supporting structure of the mirror with the correction member.

FIG. 10 is a perspective view showing a modification of the correction member.

FIG. 11 is a perspective view showing another modification of the correction member.

FIG. 12 is an explanatory view showing the operation of curvature correction using the correction member shown in FIG. 11.

FIG. 13 is a perspective view showing a correction member used in a second embodiment of the optical scanning device.

FIG. 14 is a perspective view showing the state where the correction member is attached to a mirror.

FIG. 15 is a plan view showing the movement of the correction member.

FIG. 16 is a perspective view showing the operation of curvature correction on the mirror.

FIG. 17A and FIG. 17B are plan view and front view showing an example of a turning mechanism for the correction member.

FIG. 18 is a perspective view showing a modification of the correction member according to the second embodiment.

### DETAILED DESCRIPTION

An optical scanning device of an embodiment includes:

a light source which emits a light beam;

a deflection unit which deflects the light beam emitted from the light source, in a main scanning direction;

a reflection mirror which reflects the light beam from the deflection unit toward an image carrier;

a supporting member which supports each of two ends of the reflection mirror;

a plate situated on a back side that is opposite to an incident surface for the light beam, of the mirror, along an axial line of the reflection mirror;

a holding unit which holds an end of the incident surface with an end of the plate from the back side of the mirror; and

a pressing member which presses the back side of the mirror in a curvature correcting direction against the plate.

Hereinafter, an image forming apparatus according to an embodiment will be described in detail with reference to the drawings. In the drawings, the same parts are denoted by the same reference numerals.

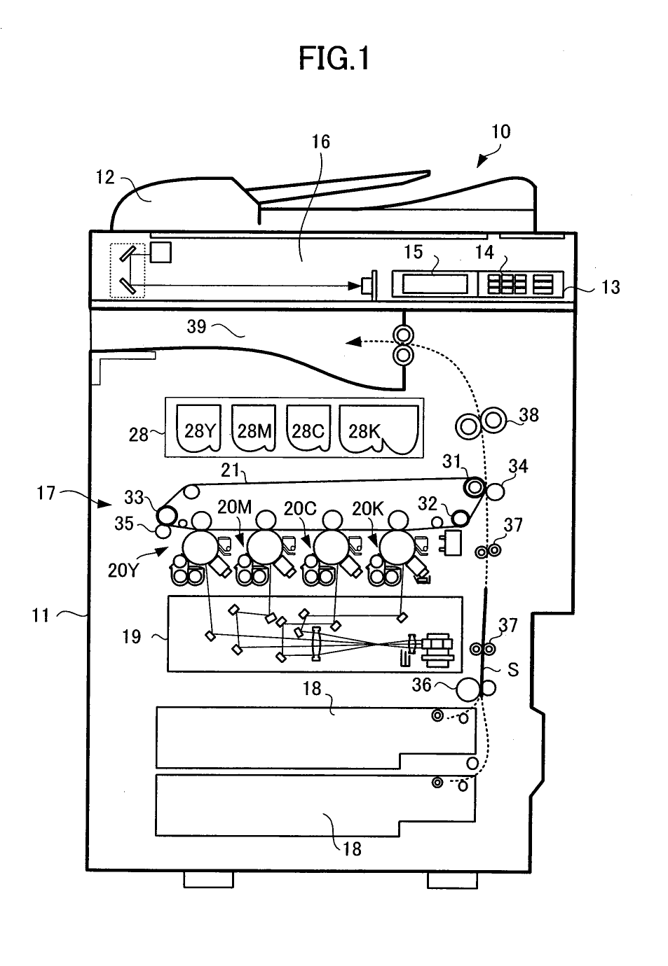

FIG. 1 is a front view showing an embodiment of an image forming apparatus. In FIG. 1, 10 represents an image forming apparatus, for example, an MFP (multi-function peripherals) as a multi-functional machine, printer or copier. In the following description, an MFP is described as an example.

There is a document table on top of a body 11 of the MFP 10. On the document table, an automatic document feeder (ADF) 12 is provided in a manner that the ADF 12 can freely open and close. On top of the body 11, an operation panel 13 is provided as well. The operation panel 13 has an operation unit 14 including various keys, and a touch panel-type display unit 15.

A scanner unit 16 is provided within the body 11, below the ADF 12. The scanner unit 16 scans a document sent by the ADF 12 or a document placed on the document table and thus generates image data. Moreover, a printer unit 17 is provided in a central part in the body 11. Plural cassettes 18 housing sheets of various sizes are provided in a lower part of the body 11.

The printer unit 17 includes photoconductive drums, a laser and the like. The printer unit 17 processes image data scanned by the scanner unit 16 or image data created by a PC (personal computer) or the like and thus forms an image on a sheet (as will be described later in detail).

The sheet on which an image is formed by the printer unit 17 is discharged to a paper discharge unit 39. The printer unit 17 is, for example, a tandem color laser printer. The printer unit 17 scans the photoconductive members with a laser beam from an optical scanning device (laser unit) 19 and thus generates an image on the photoconductive members.

The printer unit 17 includes image forming units 20Y, 20M, 20C and 20K for the colors of yellow (Y), magenta (M), cyan (C) and black (K). The image forming units 20Y, 20M, 20C and 20K are arranged in parallel from upstream toward downstream along the lower side of an intermediate transfer belt 21.

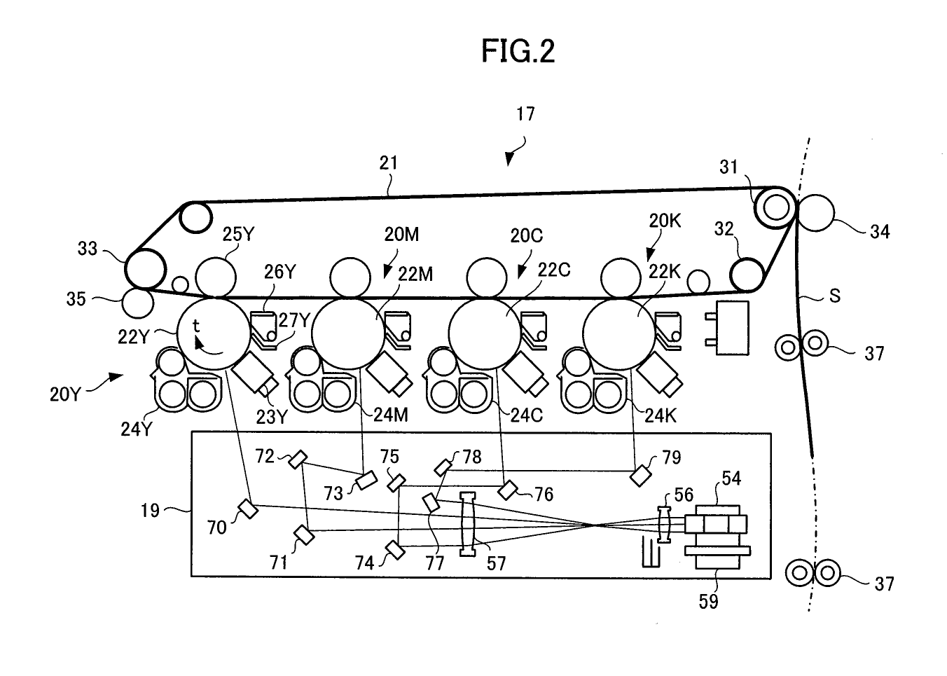

FIG. 2 shows an enlarged view of the printer unit 17 including the image forming units 20Y, 20M, 20C and 20K. In the following description, since the image forming units 20Y, 20M, 20C and 20K have the same configuration, the image forming unit 20Y is described as a representative.

As can be seen from FIG. 2, the image forming unit 20Y has a photoconductive drum 22Y as an image carrier and has a charger 23Y, a developing device 24Y, a primary transfer roller 25Y, a cleaner 26Y, a blade 27Y and the like arranged along a direction of rotation t around the photoconductive drum 22Y. An exposure position on the photoconductive drum 22Y is irradiated with a yellow laser beam from the optical scanning device 19. An electrostatic latent image is thus formed on the photoconductive drum 22Y.

The charger 23Y of the image forming unit 20Y uniformly charges the entire surface of the photoconductive drum 22Y. The developing device 24Y supplies the photoconductive drum 22Y with a two-component developer containing a yellow toner and a carrier by a developing roller to which a developing bias is applied. The cleaner 26Y uses the blade 27 to remove the residual toner on the surface of the photoconductive drum 22Y.

Above the image forming units 20Y, 20M, 20C and 20K, a toner cartridge 28 (FIG. 1) which supplies toners to the developing devices 24Y, 24M, 24C and 24K is provided. In the toner cartridge 28, toner cartridges 28Y, 28M, 28C and 28K for the colors of yellow (Y), magenta (M), cyan (C) and black (K) are arranged in proximity to each other.

The intermediate transfer belt 21 moves in a circulative manner and is made of, for example, semi-conductive polyimide in view of heat resistance and wear resistance. The intermediate transfer belt 21 is tensely laid over a driving roller 31 and driven rollers 32 and 33. The intermediate transfer belt 21 faces and contacts the photoconductive drums 22Y to 22K. At the position where the intermediate transfer belt 21 faces the photoconductive drum 22Y, a primary transfer voltage is applied by the primary transfer roller 25Y and a toner image on the photoconductive drum 22Y is primary-transferred to the intermediate transfer belt 21.

A secondary transfer roller 34 is arranged facing the driving roller 31, over which the intermediate transfer belt 21 is tensely laid. When a sheet S passes between the driving roller 31 and the secondary transfer roller 34, a secondary transfer voltage is applied by the secondary transfer roller 34 and the toner image on the intermediate transfer belt 21 is secondary-transferred to the sheet S. A belt cleaner 35 is provided near the driven roller 33 on the intermediate transfer belt 21.

Meanwhile, the optical scanning device 19 casts laser beams corresponding to image information to the photoconductive drums 22Y to 22K and thus performs scanning. With the laser beams, electrostatic latent images corresponding to the colors to be developed on the photoconductive drums 22Y to 22K are formed. The optical scanning device 19 will be described later in detail.

As shown in FIG. 1, a separation roller 36 which takes out the sheet S out of the paper supply cassettes 18 and carrying rollers 37 are provided between the paper supply cassettes 18 and the secondary transfer roller 34. A fixing device 38 is provided downstream from the secondary transfer roller 34. The paper discharge unit 39 is provided downstream from the fixing device 38.

Next, the operation of the image forming apparatus 10 shown in FIG. 1 and FIG. 2 will be described. When image data is inputted from the scanner unit 16, a PC or the like, images are sequentially formed in the image forming units 20Y to 20K.

As the image forming unit 20Y is described for an example, the photoconductive drum 22Y is irradiated with a laser beam corresponding to yellow (Y) image data and a corresponding electrostatic latent image is formed. The electrostatic latent image on the photoconductive drum 22Y is developed by the developing device 24Y and a yellow (Y) toner image is thus formed.

The photoconductive drum 22Y contacts the intermediate transfer belt 21 that is turning, and the yellow (Y) toner image is primary-transferred onto the intermediate transfer belt 21 by the primary transfer roller 25Y. After the toner image is primary-transferred to the intermediate transfer belt 21, the residual toner on the photoconductive drum 22Y is removed by the cleaner 26 and the blade 27Y. Next image formation is thus made available.

Similar to the yellow (Y) toner image forming process, magenta (M), cyan (C) and black (K) toner images are formed by the image forming units 20M to 20K, respectively. The toner images are sequentially transferred to the same position as the yellow (Y) toner image on the intermediate transfer belt 21. The yellow (Y), magenta (M), cyan (C) and black (K) toner images are multiple-transferred onto the intermediate transfer belt 21, thus acquiring a full-color toner image.

The intermediate transfer belt 21 has the full-color toner image collectively secondary-transferred onto the sheet S by a transfer bias from the secondary transfer roller 34. Synchronously with the timing when the full-color toner image on the intermediate transfer belt 21 reaches the secondary transfer roller 34, the sheet S is supplied to the secondary transfer roller 34 from the paper supply cassette 18.

The sheet S, to which the toner image is secondary-transferred, then reaches the fixing device 38 and the toner image is fixed. The sheet S having the toner image fixed is discharged to the paper discharge unit 39. Meanwhile, after the secondary transfer is finished, the residual toner on the intermediate transfer belt 21 is cleaned by the belt cleaner 35.

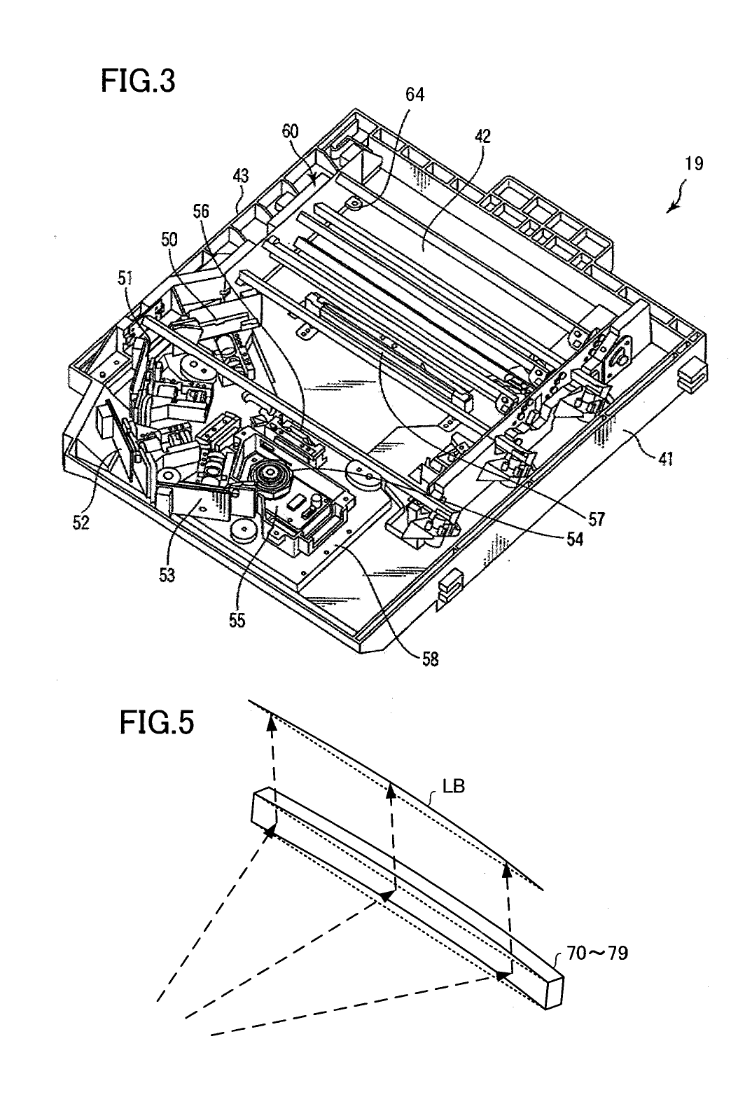

FIG. 3 is a perspective view showing the overall structure of the optical scanning device 19. The optical scanning device 19 has a casing 41. The casing 41 includes a bottom part 42 and sidewalls 43 rising from the bottom part 42 and is integrally molded, for example, using a synthetic resin. The casing 41 is made of, for example, an ABS resin (acrylonitrile butadiene styrene resin) or modified PPE (modified polyphenylene ether) reinforced by glass fibers.

A top surface of the casing 41 is covered by a cover. FIG. 3 shows the state where the cover is detached for convenience of explanation. Inside the casing 41, light sources 50, 51, 52 and 53, a polygon mirror mechanism 55 including a polygon mirror 54, a first deflection lens 56, a second deflection lens 57 and a mirror unit 60 are housed.

Each of the light sources 50 to 53 has a laser diode which outputs color-separated image light (laser beam) toward the polygon mirror 54. The light sources 50 to 53, the polygon mirror mechanism 55 and the first deflection lens 56 are loaded on a common base 58 made of, for example, an aluminum alloy. The polygon mirror 54 is rotated by a polygon motor 59 (FIG. 2) and forms a deflection unit which deflects a laser beam in the main scanning direction.

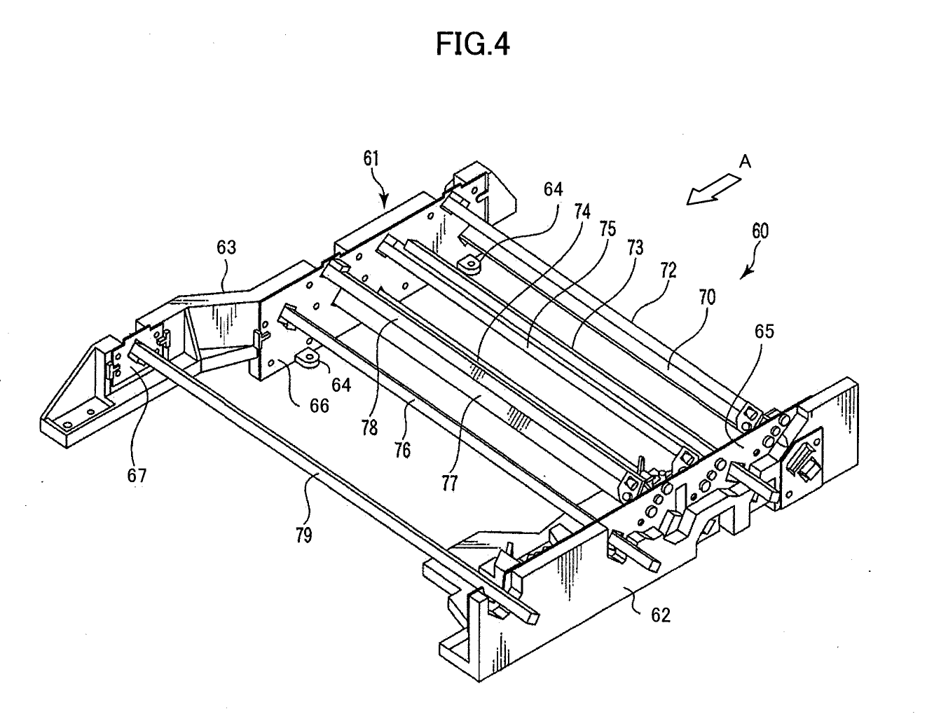

FIG. 4 is a perspective view showing the mirror unit 60 as viewed from the side of the polygon mirror 54. The mirror unit 60 includes a metallic frame 61, and reflection mirrors 70 to 79 held by the frame 61. The reflection mirrors 70 to 79 (hereinafter simply referred to as mirrors) reflect image light corresponding to each color (yellow, magenta, cyan and black), as shown in FIG. 2 as well.

For example, the mirror 70 reflects laser beams for yellow. The mirrors 71, 72 and 73 reflect laser beams for magenta. The mirrors 74, 75 and 76 reflect laser beams for cyan. The mirrors 77, 78 and 79 reflect laser beams for black. All the mirrors 70 to 79 are bar-shaped. The mirrors 70 to 75 are situated at positions far from the polygon mirror 54. The mirrors 76 to 79 are situated at positions near the polygon mirror 54.

The frame 61 of the mirror unit 60 includes a pair of base members 62 and 63 made of, for example, an aluminum alloy. Each of the base members 62 and 63 is formed by casting a metal such as an aluminum alloy and is, for example, aluminum die-cast. The base members 62 and 63 are arranged facing each other. Plural attachment parts 64 are provided at lower parts of the base members 62 and 63. The attachment parts 64 are fixed to the base part 42 of the casing 41 by fixing members such as bolts.

As shown in FIG. 4, a first mirror supporting plate 65 is attached to an inner surface of the one base member 62. A second mirror supporting plate 66 and a third mirror supporting plate 67 are attached to an inner surface of the other base member 63. The mirror supporting plates 65 and 66 are arranged parallel to each other. Each of the mirror supporting plates 65 to 67 is a metallic flat plate having a predetermined thickness.

FIG. 5 is an explanatory view showing the relation between the curvature of the mirrors and the curvature of laser beams. In FIG. 5, the mirrors 70 to 79 are originally straight linear bar-shaped as indicated by the dotted line. However, if one of the mirrors 70 to 79 is curved, a laser beam LB reflected by the mirror is similarly curved. If the photoconductive drum 22 is scanned with the curved laser beam, the quantity of curvature is large at a central part of the mirror even with a relatively small quantity of curvature, and a line written on the photoconductive drum 22 by scanning once becomes curved as well. In a color copier, since plural mirrors are used to reflect laser beams, a deviation between colors (color deviation) is generated.

In the optical scanning device 19 according to the embodiment, if one of the mirrors (70 to 79) is curved, a correction member 80 is attached to correct the curvature. Hereinafter, the configuration of the correction member 80 will be described. In the following description, the mirror 78 is taken as a representative example and assumed that the mirror 78 is curved.

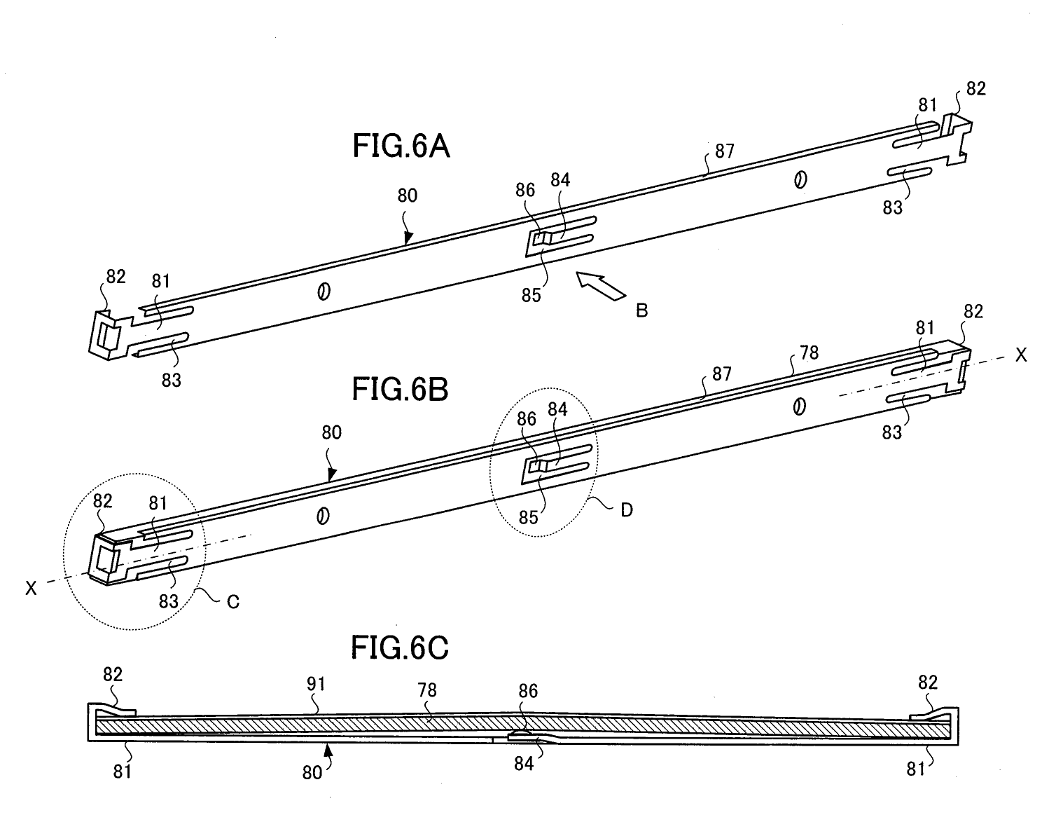

FIG. 6A is a perspective view showing the configuration of the correction member 80. FIG. 6B shows the state where the correction member 80 is attached to the mirror 78. FIG. 6 is a view showing the back side of the mirror 78 from the direction of an arrow A in FIG. 4. FIG. 6C is a sectional view along an axial line X shown in FIG. 6B.

The correction member 80 is attached to a mirror having the laser beam incident surface side curved in a concave shape (see FIG. 5) and is attached to the back side that is opposite to the incident surface (reflection surface) of the mirror. The correction member 80 need not be attached to a mirror that is not curved.

In FIG. 6A, the correction member 80 is configured in the form of a plate extending in the axial direction of the mirror 78 and is attached to the side (back side) that is opposite to the incident surface of the mirror 78. The correction member 80 is made of a plate having higher rigidity than the mirror 78. The correction member 80 has an L-shaped spring member 81 formed at each of the two ends of the plate and has a pressing member 84 at a central part.

The distal end of the spring member 81 has an acute-angled hook 82 to be hooked on the incident surface of the mirror 78. A slit 83 is formed at the distal end of the spring member 81, thus enabling the spring member 81 to be easily bent and enabling the hook 82 to be easily hooked on the distal end of the mirror 78.

A U-shaped slit 85 is formed on the periphery of the pressing member 84. The distal end of the pressing member 84 is bent toward the back side of the mirror 78. The pressing member 84 is elastic and has, at distal end of the pressing member 84, a protrusion 86 protruding toward the back side of the mirror 78 so that the protrusion 86 elastically presses the back side of the mirror 78 from the direction of an arrow B. The correction member 80 also has bent parts 87 that partly cover the lateral sides adjacent to the back side of the mirror 78. The plate body of the correction member 80 thus has a U-shaped cross section.

FIG. 6B and FIG. 6C show the state where the correction member 80 is attached to the mirror 78.

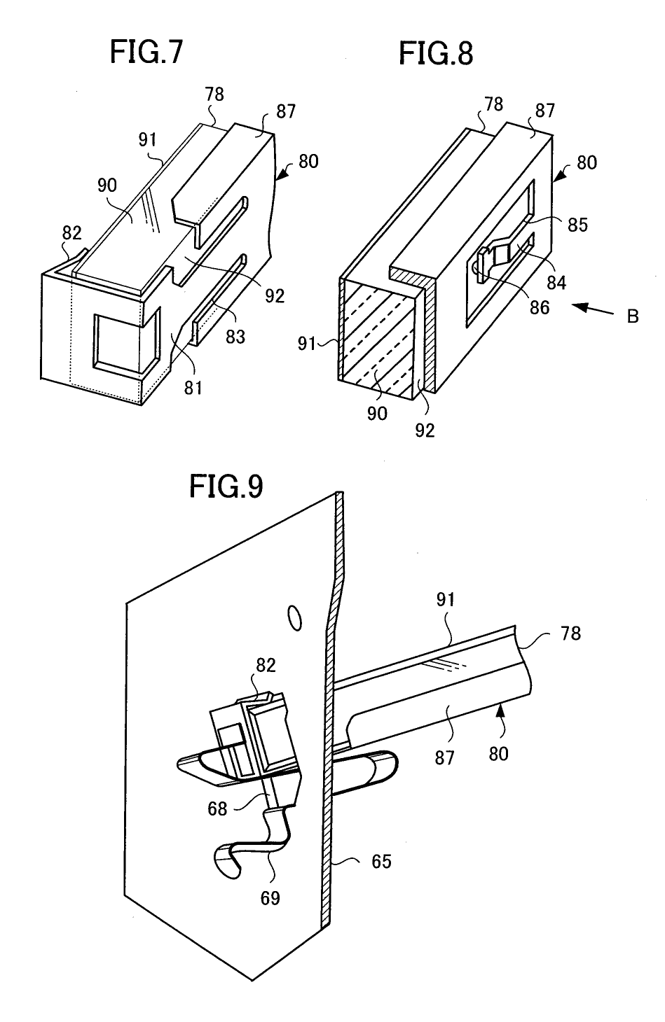

FIG. 7 shows the distal end part of the mirror 78 and the spring member 81 (indicated by a circle C in FIG. 6B), in an enlarged view. FIG. 8 shows the central part of the mirror 78 and the pressing member 84 (indicated by a circle D in FIG. 6B), in an enlarged view.

As can be seen from FIG. 7 and FIG. 8, the mirror 78 has a bar-like body 90 having a quadrilateral cross section, and a reflection layer 91 formed by evaporating aluminum on one surface of the body 90. The reflection layer 91 is an incident surface and reflection surface for laser beams.

Laser beams are cast on the incident surface 91 and the incident surface 91 reflects the cast laser beams. The correction member 80 is attached to the surface on the back side (back surface 92) of the incident surface 91. The two lateral sides adjacent to the incident surface 91 are partly covered by the bent parts 87 of the correction member 80.

FIG. 9 shows a supporting structure to support the mirror 78 having the correction member 80 in the mirror supporting plate 65. A window 68 which allows penetration by the distal end of the mirror 78 is provided in the mirror supporting plate 65. A holding spring 69 is inserted in the space between the window 68 and the mirror 78 (correction member 80). The mirror 78 is thus supported in the mirror supporting plate 65. The other end of the mirror 78 is supported in a similar supporting structure. Alternatively, another supporting structure may be used.

When the correction member 80 is attached to the mirror 78, the hook 82 of the spring member 81 is hooked on the distal end on the incident surface side of the mirror 78, as shown in FIG. 6B and FIG. 7. The hook 82 of the spring member 81 is for holding an end of the incident surface 91 from the back side of the mirror 78 and forms a holding unit formed on an end of the plate.

The protrusion 86 provided on the pressing member 84 of the correction member 80 presses the back side of the mirror 78 in a curvature correcting direction B (see FIG. 6C). Therefore, the mirror 78 has curvature corrected and becomes straight. If the laser beam incident surface side of the mirror 78 is curved in a concave shape as shown in FIG. 5, the curvature can be corrected or adjusted with the spring force of the correction member 80 alone.

Since the correction member 80 has the structure in which the pressing member 84 is substantially in contact with the backside of the mirror 78, no separate component is necessary for attaching the pressing member 84 to the correction member 80. Moreover, since the distal end of the pressing member 84 is bent toward the back side of the mirror 78, possible to make correction corresponding to the quantity of curvature of the mirror 78 by selecting the quantity of bend or the size of the protrusion 86.

The mirrors 70 to 79 in the optical scanning device 19 vary in the laser beam path, the number of times a laser beam is reflected, the laser incident angle on the mirror, and the range of reflection and use of the laser. Thus, the quantity of curvature at the time of forming an image differs even if the mirrors have the same quantity of curvature. However, the correction member 80 can be attached to each of the mirrors. Therefore, if the correction member 80 is attached only to a mirror that needs correcting, the level of the image improves.

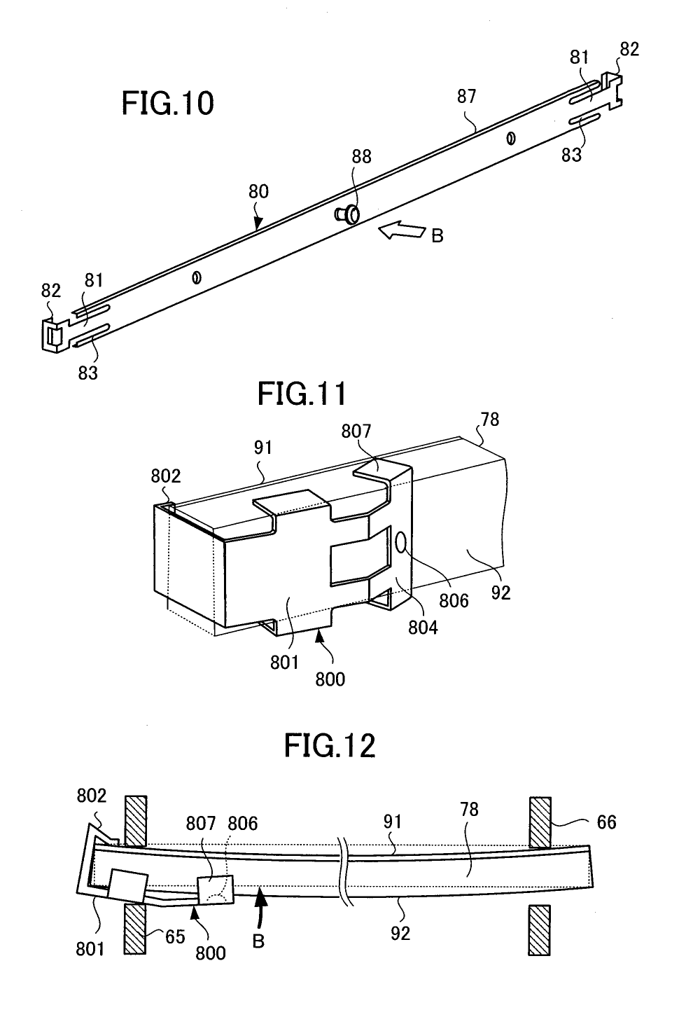

FIG. 10 shows a modification of the correction member 80. The correction member 80 shown in FIG. 10 is provided with a screw 88 instead of the pressing member 84. The screw 88 is attached to a central part of the correction member 80 and the screw 88 presses the back side of the mirror 78. By adjusting the quantity of screwing of the screw 88 is possible to adjust the quantity of correction of the mirror 78.

FIG. 11 shows another modification of the correction member. A correction member 800 shown in FIG. 11 is configured in the form of a plate attached to the mirror 78. The plate is bent opposite to the back side of the mirror 78. The correction member 800 has a spring member 801 attached to an end in the axial direction of the mirror 78, and an acute-angled hook 802 to enable one end of the spring member 801 to be hooked on the incident surface 91 of the mirror 78.

At the other end of the spring member 801, a pressing member 804 extending in the axial direction of the mirror 78 is provided. On the pressing member 804, a protrusion 806 protruding to the back side of the mirror 78 and bent parts 807 which hold the lateral sides (the surfaces adjacent to the back surface 92) of the mirror 78 are formed.

FIG. 12 shows the state where the correction member 800 is attached to one end of the mirror 78. If the laser beam incident surface side (the incident surface 91 side) is curved in a concave shape as shown in FIG. 5, the correction member 800 is attached to the back surface 92 that is opposite to the incident surface of the mirror. The hook 802 of the spring member 801 is hooked on the end in the axial direction of the mirror 78 and the bent parts 807 of the correction member 800 hold the lateral sides of the mirror 78.

Since the mirror supporting plate 65 presses the bent correction member 800, the protrusion 806 provided on the pressing member 804 presses the back side of the mirror 78. Thus, the mirror 78 is pressed in the curvature correcting direction (the direction of the arrow B) by the protrusion 806 and the curvature of the mirror can be corrected or adjusted with the spring force of the correction member 800. The holding spring 69 shown in FIG. 9 may be inserted between the mirror supporting plate 65 and the correction member 800.

The position where the correction member 800 should be attached may be set in accordance with the degree of curvature of the mirror and the correction member 800 may be attached not only on one end side of the mirror 78 but also on the other end side. Moreover, plural types of correction members 800 having different spring forces may be prepared and a correction member 800 that has a suitable spring force for correction may be attached in accordance with the degree of curvature of the mirror 78.

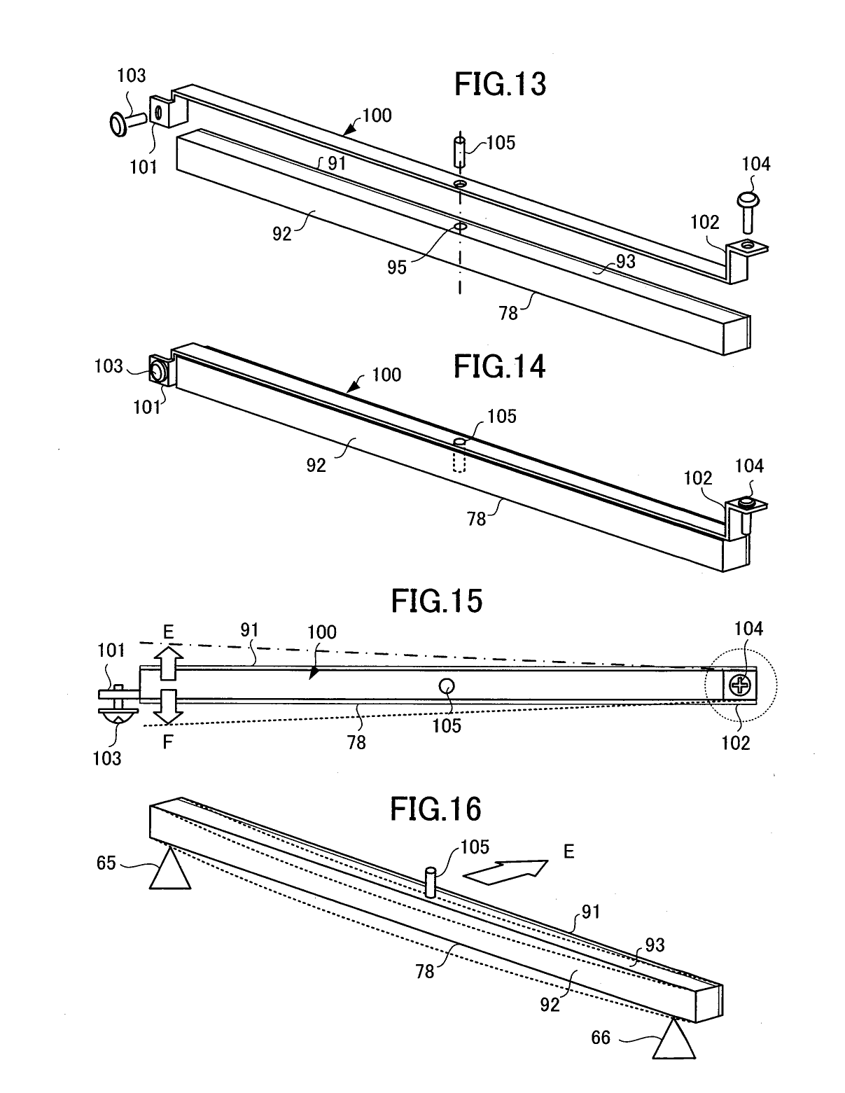

Next, a second embodiment of the optical scanning device 19 will be described. In the second embodiment, a correction member 100 shown in FIG. 13 is used in order to correct the curvature of the mirror. In the following description assumed that the mirror 78 is curved.

In FIG. 13, the correction member 100 is configured in the form of a plate extending in the axial direction of the mirror 78 and is attached to a lateral surface 93 adjacent to the reflection surface of the mirror 78. The correction member 100 is made of a steel plate or the like having higher rigidity than the mirror 78. One end 101 of the correction member 100 can turn in a direction orthogonal to the axial line of the mirror 78, using other end 102 as the fulcrum.

The quantity of turning of the one end 101 of the correction member 100 is adjusted by an adjustment member such as a screw 103. The other end 102 of the correction member 100 is attached to a fixed member such as the mirror supporting plate 66 with a screw 104. A pin 105 is inserted in a central part of the correction member 100.

In the mirror 78, a hole 95 is provided at a position facing the pin 105. The pin 105 is inserted in the hole 95. Both ends of the mirror 78 are fixed to the mirror supporting plates 65 and 66. An arbitrary fixing method can be employed.

FIG. 14 is a perspective view showing the state where the correction member 100 is attached to the mirror 78. The mirror 78 and the correction member 100 are connected to each other with the pin 105.

The operation of curvature correction for the mirror according to the second embodiment will be described with reference to FIG. 15 and FIG. 16. FIG. 15 is a plan view of the correction member 100 and the mirror 78. FIG. 16 is a perspective view showing the operation of curvature correction for the mirror 78. As shown in FIG. 15, the one end 101 of the correction member 100 can turn in a direction E indicated by the chain-dotted line or in a direction F indicated by the dotted line, using the screw 104 as the fulcrum.

As the correction member 100 is turned, the central part of the mirror 78 is pulled in the direction E or in the direction F by the pin 105 because both ends of the mirror 78 are fixed. Thus, the correction member 100 can be turned in the direction of correcting the curvature of the mirror 78. The load applied to the mirror 78 can be adjusted by the adjustment member such as the screw 103. FIG. 16 shows an example in which when the laser beam incident surface (incident surface 91) of the mirror 78 is curved in a concave shape as indicated by the dotted line, the correction member 100 is turned in the direction E to correct the curvature.

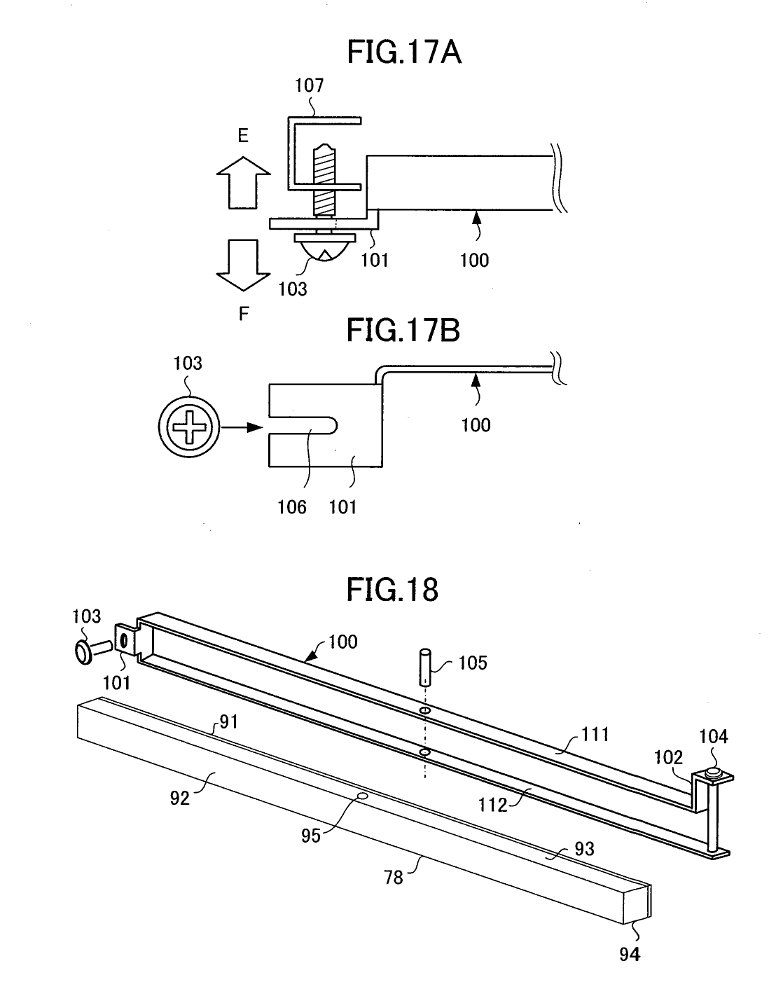

FIG. 17A and FIG. 17B show an example of a turning mechanism for turning the one end 101 of the correction member 100. FIG. 17A is a plan view. FIG. 17B is a view of the one end 101 as viewed from the front.

The stepped screw 103 is attached to the one end 101 of the correction member 100. On the one end 101, a slit 106 in which the thin trunk part of the screw 103 is to be inserted is formed, as shown in FIG. 17B. The screw 103 can be screwed into a fixed member 107. If the screw 103 is rotated in one direction, the one end 101 turns in the direction E. If the screw 103 is rotated in the opposite direction, the one end 101 turns in the direction F. The turning mechanism is not limited to the example shown in FIG. 17A and FIG. 17B and various mechanisms can be used.

FIG. 18 shows a modification of the correction member 100. The correction member 100 extends in the axial direction of the mirror 78 and includes upper and lower plates 111 and 112 to sandwich two lateral sides 93 and 94 adjacent to the incident surface 91 of the mirror 78. A hole which allows penetration by the pin 105 is provided at central parts of the plates 111 and 112. The one end 101 of the correction member 100 can turn in the direction orthogonal to the axial line of the mirror 78 as in FIG. 15, using the other end 102 as the fulcrum.

The quantity of turning of the one end 101 of the correction member 100 is adjusted by the adjustment member such as the screw 103. The other end 102 of the correction member 100 is attached to a fixed member such as the mirror supporting plate 66 with the screw 104. The pin 105 is inserted in a central part of the correction member 100.

In the mirror 78, the hole 95 is provided at a position facing the pin 105. The pin 105 is inserted in the hole 95. Both ends of the mirror 78 are fixed to the mirror supporting plates 65 and 66. An arbitrary fixing method can be employed. The mirror 78 and the correction member 100 are connected to each other with the pin 105. Since the pin 105 is supported between the upper and lower plates 111 and 112, the curvature of the mirror 78 can be corrected strongly.

In the second embodiment, whether the laser beam incident surface (incident surface 91) of the mirror 78 is curved in a concave shape or curved in a convex shape, the curvature can be corrected by the turning of the correction member 100 with the adjustment member such as the screw 103.

The invention is not limited to the above embodiments and various modifications can be made.

While certain embodiments have been described, these embodiments have been presented by way of example only, and are not intended to limit the scope of the invention. Indeed, the novel devices, methods and apparatus described herein may be embodied in a variety of other forms. Furthermore, various omissions, substitutions and changes in the forms of the devices, methods and apparatus described herein may be made without departing from the spirit of the invention. The accompanying claims and their equivalents are intended to cover such forms or modifications as would fall within the scope and spirit of the invention.

1. An optical scanning device comprising:
a light source which emits a light beam;
a deflection unit which deflects the light beam emitted from the light source, in a main scanning direction;
a reflection mirror which reflects the light beam from the deflection unit toward an image carrier;
a supporting member which supports each of two ends of the reflection mirror;
a plate situated on a back side that is opposite to an incident surface for the light beam, of the reflection mirror, along an axial line of the reflection mirror;
a holding unit which holds an end of the incident surface with an end of the plate from the back side of the reflection mirror; and
a pressing member which presses the back side of the reflection mirror in a curvature correcting direction against the plate.

2. The device of claim 1, wherein the plate has higher rigidity than the reflection mirror.

3. The device of claim 1, wherein the plate extends along the axial line of the reflection mirror, the holding unit in the form of a hook which holds both ends of the reflection mirror from the back side is formed at both ends of the plate, and the pressing member is formed at a central part of the plate.

4. The device of claim 3, wherein the holding unit has a hook having an acute angle with respect to an end of the reflection mirror.

5. The device of claim 3, wherein the pressing member is an elastic piece formed by bending the central part of the plate toward the back side of the reflection mirror.

6. The device of claim 3, wherein the pressing member is a screw member that can be screwed into the plate and presses the back side of the reflection mirror in the curvature correcting direction.

7. The device of claim 1, wherein the plate extends along the axial line of the reflection mirror and is bent opposite to the back side of the reflection mirror, the holding unit in the form of a hook which holds one end of the reflection mirror from the back side is formed at one end of the plate, and the pressing member is formed at other end of the plate, and
the plate is arranged between one end on the back side of the reflection mirror and the supporting member which supports one end of the reflection mirror.

8. The device of claim 7, wherein the holding unit has a hook having an acute angle with respect to an end of the reflection mirror.

9. A beam curvature correction method comprising:
deflecting a light beam emitted from a light source which emits the light beam, in a main scanning direction;
supporting each of two ends of a reflection mirror by a supporting member;
reflecting the deflected light beam toward an image carrier by the reflection mirror;
attaching a plate to a back side that is opposite to an incident surface for the light beam, of the reflection mirror, along an axial line of the reflection mirror;
holding an end of the incident surface with an end of the plate from the back side of the reflection mirror; and
pressing the back side of the reflection mirror in a curvature correcting direction against the plate.

10. The method of claim 9, wherein the plate has higher rigidity than the reflection mirror.

11. The method of claim 9, wherein the plate extends along the axial line of the reflection mirror, and both ends of the reflection mirror is held from the back side by a hook-like holding unit formed at both ends of the plate, and
the back side of the reflection mirror is pressed in the curvature correcting direction by a pressing member formed at a central part of the plate.

12. The method of claim 11, wherein the pressing member is formed by bending the central part of the plate toward the back side of the reflection mirror.

13. The method of claim 11, wherein the pressing member is capable of screwing a screw member into the plate, and the back side of the reflection mirror is pressed in the curvature correcting direction by the screw member.

14. The method of claim 9, wherein the plate extends along the axial line of the reflection mirror and is bent opposite to the back side of the reflection mirror, one end of the reflection mirror is held from the back side by a hook-like holding unit formed at one end of the plate, and the back side of the reflection mirror is pressed in the curvature correcting direction by a pressing member formed at other end of the plate, and
the plate is arranged between one end on the back side of the reflection mirror and the supporting member which supports one end of the reflection mirror.

15. An image forming apparatus comprising:
an image carrier which carries a latent image;
a light source which emits a light beam;
a deflection unit which deflects the light beam emitted from the light source, in a main scanning direction;
a reflection mirror which reflects the light beam from the deflection unit toward the image carrier;
a supporting member which supports each of two ends of the reflection mirror;
a plate situated on a back side that is opposite to an incident surface for the light beam, of the reflection mirror, along an axial line of the reflection mirror;
a holding unit which holds an end of the incident surface with an end of the plate from the back side of the reflection mirror;
a pressing member which presses the back side of the reflection mirror in a curvature correcting direction against the plate and;
a developing device which develops the latent image carried by the image carrier.

16. The apparatus of claim 15, wherein the plate has higher rigidity than the reflection mirror.

17. The apparatus of claim 15, wherein the plate extends along the axial line of the reflection mirror, the holding unit in the form of a hook which holds both ends of the reflection mirror from the back side is formed at both ends of the plate, and the pressing member is formed at a central part of the plate.

18. The apparatus of claim 17, wherein the pressing member is an elastic piece formed by bending the central part of the plate toward the back side of the reflection mirror.

19. The apparatus of claim 17, wherein the pressing member is a screw member that can be screwed into the plate and presses the back side of the reflection mirror in the curvature correcting direction.

20. The apparatus of claim 15, wherein the plate extends along the axial line of the reflection mirror and is bent opposite to the back side of the reflection mirror, the holding unit in the form of a hook which holds one end of the reflection mirror from the back side is formed at one end of the plate, and the pressing member is formed at other end of the plate, and
the plate is arranged between one end on the back side of the reflection mirror and the supporting member which supports one end of the reflection mirror.
